(19) United States
(12) Patent Application Publication
(10) Pub. No.: US 2010/0154938 A1
(43) Pub. Date: Jun. 24, 2010

(54) Layered fe-based alloy and process for production thereof

(75) Inventors: Toshimasa Kumaki, Tochigi-ken (JP); Kazuo Matsushita, Tochigi-ken (JP); Mitsuo Kuwabara, Tochigi-ken (JP); Masanori Kosugi, Tochigi-ken (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Motor Co., Ltd

(21) Appl. No.: 11/989,871

(22) PCT Filed: Aug. 2, 2006
(86) PCT No.: PCT/JP2006/315297

§ 371 Date: Feb. 1, 2008

(30) Foreign Application Priority Data
Aug. 2, 2005 (JP) 2005-224176

(51) Int. Cl. C23C 8/26; C23C 8/32; B32B 15/04; C22C 38/00

(52) U.S. Cl. 148/230; 148/318

(57) ABSTRACT

The surface of a pre-molded article made of SKH51 (Fe-based alloy) is coated with a powder of Al, Cr and the like. The coating may be performed by applying a coating agent which is prepared by dispersing the powder in an organic solvent. The coating agent may contain a reducing agent. After coating, the pre-molded article is subjected to heat treatment to form a carbonized product of the metal. The pre-molded article may be further treated with nitrogen, thereby forming a layered Fe-based alloy which has a diffusion layer which is formed by the diffusion of the carbonized product, a nitrided product and AIN in the base material. Subsequently, the article may be subjected to finishing process to give a punch having a predetermined shape for use in a hot-roll forging process.

### TECHNICAL FIELD

The present invention relates to a layered Fe-based alloy provided with a diffusion layer on a surface of a base material composed of an Fe-based alloy, the diffusion layer containing carbide and nitride and having a hardness higher than that of the base material, and a method (process) for producing the same.

### BACKGROUND ART

A coating may be provided on the surface of a steel material made up of an Fe-based alloy by, for example, physical vapor deposition (PVD), chemical vapor deposition (CVD), plating, or anodic oxidation, in order to improve various characteristics including, for example, abrasion resistance, corrosion resistance, and strength of the material. However, in the methods described above, a long period of time is required to form the coating, and the cost for forming the coating is expensive.

In view of the above, as described, for example, in Japanese Laid-Open Patent Publication No. 2003-129216 and Japanese Laid-Open Patent Publication No. 2003-239039, procedures have been widely carried out, in which a variety of surface treatments such as carburization, sulfurizing, nitriding, and carbonitriding have been applied to improve various surface characteristics of steel materials without the use of coatings. Further, Japanese Laid-Open Patent Publication No. 05-171442 suggests that a compressive stress of 10 kgf/cm² (about 0.1 MPa) may be applied to the surface through a mechanical treatment, such as shot peening or shot blasting, in order to improve abrasion resistance and breakage resistance of a machining blade.

Further, attention is focused on the corrosion resistance of an Fe—Al alloy in Japanese Patent No. 3083292 and Japanese Laid-Open Patent Publication No. 2004-323891, and it is attempted that Al is allowed to diffuse and permeate into a steel material by being subjected to a heat treatment. In order to realize this procedure, it has been suggested in Japanese Patent No. 3083292 that a heat treatment is performed while applying an Al powder or an Al alloy powder and a Ti powder or a Ti alloy powder to a steel material. On the other hand, it has been suggested in Japanese Laid-Open Patent Publication No. 2004-323891 that a heat treatment is performed while applying a mixed powder of an Al powder and an Al alloy powder and at least one of metal oxide, metal nitride, metal carbide, and metal boride to a steel material.

However, improvements in various characteristics brought about by the conventional techniques described in Japanese Laid-Open Patent Publication Nos. 2003-129216, 2003-239039 and 05-171442, are limited to the surface of the metal material. For example, in the case of nitriding and carburization, an element is diffused over a distance of only several μm to a maximum of about 200 μm from the surface of the metal material. It is difficult to improve such characteristics at inner positions deeper than the above. Therefore, it cannot be assured that abrasion resistance and breakage resistance are remarkably improved.

Additionally, in the case of the treatment methods concerning the conventional techniques, the interface exists between the formed nitride layer or the like and the metal material as the base material. Therefore, the brittle fracture may disadvantageously occur from the interface under a condition in which the stress is concentrated on the interface.

The depth of diffusion and permeation of Al is also about 100 μm in the techniques described in Japanese Patent No. 3083292 and Japanese Laid-Open Patent Publication No. 2004-323891 as well. Therefore, it is difficult to improve the various characteristics at internal portions disposed deep inside the metal material.

### DISCLOSURE OF THE INVENTION

A general object of the present invention is to provide a layered Fe-based alloy with improved hardness and strength to deep inside thereof.

A principal object of the present invention is to provide a layered Fe-based alloy in which brittle fractures and concentrations of stress rarely occur, because properties change gradually.

Another object of the present invention is to provide a method for producing a layered Fe-based alloy as described above.

According to an aspect of the present invention, there is provided a layered Fe-based alloy comprising a base material composed of an Fe-based alloy and a diffusion layer which is formed by diffusion of a carbide and a nitride from a surface side of the base material and which has a hardness higher than that of the base material, wherein

at least AlN is contained as the nitride; and

concentrations of the carbide and the nitride are progressively decreased at deeper positions in the diffusion layer.

In the layered Fe-based alloy according to the present invention, the carbide and the nitride containing AlN are diffused to deep inside the Fe-based alloy as the base material. Therefore, the excellent hardness and strength are exhibited at deep inside the Fe-based alloy as well. Further, no interface exists between the diffusion layer and the base material in the layered Fe-based alloy. Therefore, the stress concentration does not tend to occur, and hence the brittle fracture is unlikely to occur.

The compressive residual stress is applied due to the presence of, for example, the nitride and the carbide. However, in the present invention, the carbide and the nitride are diffused equal to or deeper than 0.5 mm from the start point of the outermost surface. Therefore, it is possible to increase the compressive residual stress at the deep inner portions. Because the concentrations of the carbide and the nitride are progressively decreased from the outermost surface to the inside, the compressive residual stress is also progressively decreased. Also in this viewpoint, the stress concentration is avoided.

Preferred examples of the metal carbide include carbides of Cr, W, Mo, V, Ni, and Mn. Preferred examples of the metal nitride include nitrides of Cr, W, Mo, V, Ni, and Mn in addition to AlN.

It is preferable that the carbide has a compositional formula of M₆C or M₂₃C₆ wherein M represents a metal element, for the following reason. Namely, carbide, which has a compositional formula represented as described above, is especially excellent in improving hardness of the Fe-based alloy.

The carbide may be obtained by carbonizing a solid solution of Fe and at least one of Cr, W, Mo, V, Ni, and Mn. In this case, the relative amount of the aforementioned metal carbide is reduced. Therefore, any increase in brittleness, which would be caused by excessively producing metal carbide, is suppressed.

A preferred carbide for the solid solution has a compositional formula represented by (Fe, M)₆C or (Fe, M)₂₃C₆, wherein M represents a metal element.

The features as described above are also applicable to the following description in the same manner as described above.

According to another aspect of the present invention, there is provided a method for producing a layered Fe-based alloy comprising a base material composed of an Fe-based alloy and a diffusion layer which is formed by diffusion of a carbide and a nitride in the base material and which has a hardness higher than that of the base material, wherein at least AlN is contained as the nitride, the method comprising the steps of:
applying metal powder which contains Al powder to a surface of the Fe-based alloy;
heat-treating the Fe-based alloy applied with the powder; and
nitriding the heat-treated Fe-based alloy.

When the steps as described above are performed, then the diffusion layer having a large thickness can be formed, and it is possible to produce the layered Fe-based alloy in which no interface exists between the diffusion layer and the base material. The obtained layered Fe-based alloy is excellent in hardness and strength, because the diffusion layer is present.

According to still another aspect of the present invention, there is provided a layered Fe-based alloy comprising a base material composed of an Fe-based alloy and a diffusion layer which is formed by diffusion of a carbide and a nitride from a surface side of the base material and which has a hardness higher than that of the base material, wherein
concentrations of the carbide and the nitride are progressively decreased at deeper positions in the diffusion layer.

The layered Fe-based alloy may or may not contain AlN as the nitride.

According to still another aspect of the present invention, there is provided a method for producing a layered Fe-based alloy comprising a base material composed of an Fe-based alloy and a diffusion layer which is formed by diffusion of a carbide and a nitride from a surface side of the base material and which has a hardness higher than that of the base material, wherein concentrations of the carbide and the nitride are progressively decreased at deeper positions in the diffusion layer, the method comprising the steps of:
applying metal powder which contains Al powder to a surface of the Fe-based alloy; and
subjecting the Fe-based alloy to a nitriding treatment in a nitriding gas atmosphere.

That is, in this procedure, the heat treatment for diffusion and the nitriding treatment are simultaneously performed.

According to still another aspect of the present invention, there is provided a layered Fe-based alloy comprising a base material composed of an Fe-based alloy and a diffusion layer which is formed by diffusion of a carbide and a nitride from a surface side of the base material and which has a hardness higher than that of the base material, wherein

hardness is progressively decreased as concentrations of the carbide and the nitride are progressively decreased at deeper positions in the diffusion layer, and a difference between a maximum hardness and a minimum hardness, which is provided at a part ranging from an outermost surface to a depth of 0.1 mm, is within 10% as evaluated with a value of Vickers hardness.

In the case of the steel material in which the difference in hardness is small, strain is decreased, and fatigue resistance is further increased. Therefore, it is possible to realize a long service life as compared with a steel material subjected to an ordinary nitriding treatment.

According to still another aspect of the present invention, there is provided a method for producing a layered Fe-based alloy comprising a base material composed of an Fe-based alloy and a diffusion layer which is formed by diffusion of a carbide and a nitride from a surface side of the base material and which has a hardness higher than that of the base material, wherein hardness is progressively decreased as concentrations of the carbide and the nitride are progressively decreased at deeper positions in the diffusion layer, and a difference between a maximum hardness and a minimum hardness, which is provided at a part ranging from an outermost surface to a depth of 0.1 mm, is within 10% as evaluated with a value of Vickers hardness, the method comprising the steps of:
applying metal powder to a surface of the Fe-based alloy;
heat-treating the Fe-based alloy applied with the metal powder;
applying the metal powder to the surface of the Fe-based alloy again; and
subjecting the Fe-based alloy to which the metal powder has been applied again to a nitriding treatment.

That is, in this procedure, the heat treatment is performed after applying the metal powder. Further, the nitriding treatment is performed after the metal powder is applied again. When the steps as described above are performed, the difference in hardness is decreased in the part (in the vicinity of the outermost surface) ranging from the outermost surface to the depth of 0.1 mm. Therefore, it is possible to obtain a layered Fe-based alloy having small strain and large fatigue resistance.

Additionally, according to this production method, it is possible to form the diffusion layer having the large thickness, and it is possible to produce the layered Fe-based alloy in which no interface exists between the diffusion layer and the base material. Further, it is possible to improve various characteristics of arbitrary parts irrelevant to the shape of the Fe-based alloy. The obtained layered Fe-based alloy is excellent in hardness and strength, because the diffusion layer is present.

According to still another aspect of the present invention, there is provided a layered Fe-based alloy comprising a base material composed of an Fe-based alloy containing a pearlite microstructure and a diffusion layer which is formed by diffusion of a carbide and a nitride from a surface side of the base material and which has a hardness higher than that of the base material, wherein
concentrations of the carbide and the nitride are progressively decreased at deeper positions in the diffusion layer.

According to still another aspect of the present invention, there is provided a layered Fe-based alloy comprising a base material composed of an Fe-based alloy containing a troostite microstructure or a sorbite microstructure and a diffusion layer which is formed by diffusion of a carbide and a nitride from a surface side of the base material and which has a hardness higher than that of the base material, wherein
concentrations of the carbide and the nitride are progressively decreased at deeper positions in the diffusion layer.

That is, the two types of the layered Fe-based alloys described above include the microstructures formed by a hardening treatment and a tempering treatment. When the tempering temperature is less than 400° C., the pearlite microstructure is formed. When the tempering temperature is not less than 400° C., the troostite microstructure or the sorbite microstructure is formed.

The Fe-based alloy, to which the hardening treatment is applied, exhibits the high hardness. The Fe-based alloy to which the tempering treatment is applied is improved in brittleness. Therefore, the two types of the Fe-based alloys described above exhibit high hardness, while exhibiting improvement in brittleness.

According to still another aspect of the present invention, there is provided a method for producing a layered Fe-based alloy comprising a base material composed of an Fe-based alloy containing a pearlite microstructure and a diffusion layer which is formed by diffusion of a carbide and a nitride from a surface side of the base material and which has a hardness higher than that of the base material, wherein concentrations of the carbide and the nitride are progressively decreased at deeper positions in the diffusion layer, the method comprising the steps of:
applying a hardening treatment to the Fe-based alloy and then performing a tempering treatment by heating the Fe-based alloy to a temperature of not less than 150° C. and less than 400° C.;
applying metal powder to a surface of the Fe-based alloy; and
subjecting the Fe-based alloy to a nitriding treatment.

According to still another aspect of the present invention, there is provided a method for producing a layered Fe-based alloy comprising a base material composed of an Fe-based alloy containing a troostite microstructure or a sorbite microstructure and a diffusion layer which is formed by diffusion of a carbide and a nitride from a surface side of the base material and which has a hardness higher than that of the base material, wherein concentrations of the carbide and the nitride are progressively decreased at deeper positions in the diffusion layer, the method comprising the steps of:
applying a hardening treatment to the Fe-based alloy and then performing a tempering treatment by heating the Fe-based alloy to a temperature of not less than 400° C. and not more than an Ac1 transformation temperature;

applying metal powder to a surface of the Fe-based alloy; and
subjecting the Fe-based alloy to a nitriding treatment.

That is, according to the present invention, the microstructure, which is contained in the base material, can be allowed to differ by changing the tempering temperature. In particular, when the operation (refining), in which the troostite microstructure or the sorbite microstructure is deposited by the tempering treatment, is performed, it is possible to obtain the layered Fe-based alloy having high toughness.

The method for producing the layered Fe-based alloy of the present invention also includes the case where so-called refining material is used. The refining material is commercially available in the state where the material has been subjected to the hardening treatment and then the tempering treatment at a temperature of less than 400° C. and not more than an Ac1 transformation temperature. The metal microstructure thereof contains the troostite microstructure or the sorbite microstructure. That is, when the refining material is used, then the material is available in such a state that the hardening treatment and the tempering treatment are previously performed, and then the residual steps are carried out. Therefore, all of the steps described above are consequently carried out.

When the steps as described above are performed, it is possible to form the diffusion layer having a large thickness, and it is possible to produce the layered Fe-based alloy in which no interface exists between the diffusion layer and the base material. The obtained layered Fe-based alloy is excellent in hardness and strength, because the diffusion layer is present.

### BRIEF DESCRIPTION OF THE DRAWINGS

FIG. 1 is a schematic perspective view illustrating an entire hot forging punch as a layered Fe-based alloy;

FIG. 2 is a magnified longitudinal sectional view an illustrating major portion of the hot forging punch shown in FIG. 1;

FIG. 3 is a flow of the process for producing the hot forging punch shown in FIG. 1;

FIG. 4 is a graph illustrating the relationship between the depth and the compressive residual stress in respective steel materials after applying the nitriding treatment;

FIG. 5 is a graph illustrating the Vickers hardness as measured while being directed to the inside from a cut surface of a hot forging punch according to a first embodiment;

FIG. 6 is a graph illustrating the Vickers hardness as measured while being directed to the inside from a cut surface of a hot forging punch according to a second embodiment;

FIG. 7 is a flow of the process for producing a hot forging punch according to a third embodiment;

FIG. 8 is a graph illustrating the Vickers hardness as measured while being directed to the inside from a cut surface of the hot forging punch according to the third embodiment;

FIG. 9 is a flow of the process for producing a hot forging punch according to a fourth embodiment; and

FIG. 10 is a graph illustrating the Vickers hardness as measured while being directed to the inside from a cut surface of the hot forging punch according to the fourth embodiment.

### BEST MODE FOR CARRYING OUT THE INVENTION

The layered Fe-based alloy of the present invention will be explained in detail below with reference to the accompanying drawings, which exemplify preferred embodiments of the invention in relation to the method for producing the same.

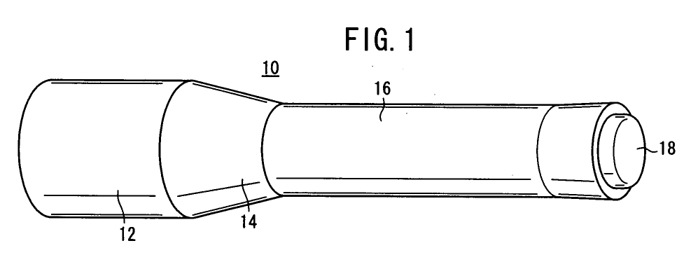

FIG. 1 schematically shows a perspective view, illustrating an entire hot forging punch formed of a layered Fe-based alloy according to a first embodiment. The hot forging punch 10 is manufactured using SKH51 as a raw material (base material). The hot forging punch 10 has a large diameter section 12, a diametrally reduced section 14 connected to the large diameter section 12 and having diameters thereof gradually reduced in a tapered shape, a small diameter section 16, and a curved protruding section 18 that protrudes from one end of the small diameter section 16. The curved protruding section 18 and a side wall of a forward end of the small diameter section 16 are used to press a workpiece, which is accommodated in a cavity of an unillustrated die, so that the workpiece is formed to have a predetermined shape. That is, the forward end of the small diameter section 16 and the curved protruding section 18 are forming portions pressing a workpiece.

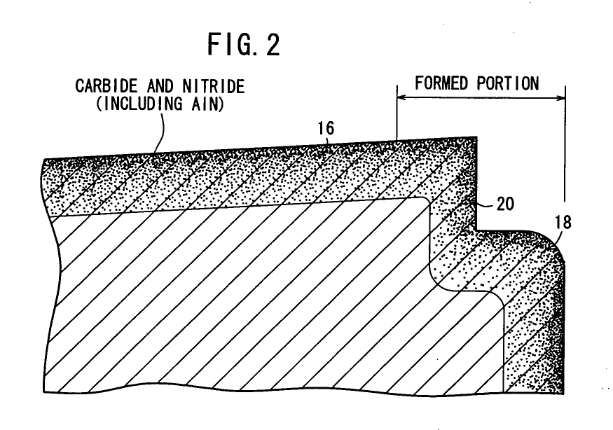

A cross section of the forming portions is magnified and shown in FIG. 2. As shown in FIG. 2, a diffusion layer 20, which is formed by diffusion of a metal carbide and a metal nitride into an SKH51 base material, is provided at a surface layer portion of the forming portions.

Further, nitrogen diffuses and permeates into the portion in the vicinity of the outmost surface of the forming portions. That is, nitrogen is contained in the base material as the underlying material in a form of so-called nitride layer or nitrided layer (nitrogen diffusion layer) formed by the nitriding treatment in addition to the carbide and the nitride in the vicinity of the outermost surface of the diffusion layer 20.

Preferred examples of the metal element used for forming carbide and nitride include Cr, W, Mo, V, Ni, and Mn. The diffusion layer 20, which is formed by diffusion of the carbide and nitride of the metal elements described above, exhibits high hardness and high strength due to the same mechanism as in a precipitation-hardened complex material.

Further, the nitrided layer, which is formed by diffusion and permeation of nitrogen as described above, exists in the vicinity of the outermost surface of the diffusion layer 20. Therefore, the forming portions of the hot forging punch 10, in which the diffusion layer 20 exists, exhibits high hardness and high strength as compared with, for example, the large diameter section 12 and the diametrally reduced section 14 in which the diffusion layer 20 does not exist. In other words, the forming portions, provided with the diffusion layer 20, exhibits high hardness and high strength as compared with the other parts of hot the hot forging punch 10.

The carbide may be a carbide having a compositional formula represented by M₇C₃, in which the metal element is represented by M. However, it is preferable to use a carbide represented by M₆C (such as Cr₆C, W₆C, and Mo₆C) or a carbide represented by M₂₃C₆, for the following reason. Namely, in this case, the carbide is highly excellent in its effect to improve hardness and strength.

If too much M₆C and/or M₂₃C₆ is used and exists excessively, the hot forging punch 10 exhibits brittleness. Accordingly, it is preferable to form a carbide from a solid solution of Fe and the above-described metal elements. That is, the carbide may be represented by, for example, (Fe, M)₆C and (Fe, M)₂₃C₇. When such a carbide is produced, the relative amount of M₆C and/or M₂₃C₆ is reduced. Therefore, the hot forging punch 10 is reliably prevented from becoming brittle.

For example, when the amount of C in the steel material is large, for example, WC, VC, Mo₂C, and Cr₃C₄ exist as carbides in some cases in addition to those represented by the composition formulas as described above.

Preferred example of the nitride includes nitrides of Cr, W, Mo, V, Ni, and Mn as described above. In particular, Cr is especially preferred. In this embodiment, AlN is also contained in the diffusion layer 20 in addition to the nitride as described above. The nitride as described above exists so that the nitride is allowed to intervene between the fine carbide and the deposited austenite.

In this arrangement, the thickness of the diffusion layer 20, or in other words the distance at which the carbide and the nitride are diffused, is at least at a depth of 0.5 mm (500 μm) from the surface of the hot forging punch 10. The thickness or distance usually is from 3 to 7 mm (3,000 to 7,000 μm), and the thickness or distance occasionally reaches 15 mm (15,000 μm), at a maximum. Such values are extremely large, as compared with diffusion distances obtained using ordinary nitriding or carburization, which only are of several tens of μm, or reaching about as much as 200 μm. That is, in the embodiment of the present invention, the carbide and the nitride are diffused extremely deeply as compared with depths obtained when the element is introduced using a conventional surface treatment technique.

Further, in the first embodiment, AlN is diffused to a depth which is substantially equivalent to the thickness of the diffusion layer 20. In other words, AlN arrives at the depth of at least 0.5 mm from the outermost surface. Therefore, the diffusion layer 20 is in a form of containing AlN. AlN may be diffused to the deep position as compared with the carbide and other nitrides.

In the forming portions provided with the diffusion layer 20 as described above, hardness of the base material is improved throughout the depth at which the carbide and the nitride are diffused. That is, hardness and strength are increased throughout a region that penetrates deep inside of the hot forging punch 10. As a result, abrasion resistance is improved internally, and the hot forging punch 10 is prevented from becoming deformed.

For example, carbonitride of Cr, W, Mo, V, Ni, and/or Mn may be contained in the diffusion layer 20 in addition to the carbide and the nitride as described above.

The diffusion layer 20 is formed such that the metal element, which is diffused from the surface of the base material, produces a carbide and a nitride, as shall be described later on. Therefore, concentration of the carbide and the nitride is the highest at the surface, and the concentration of the carbide gradually decreases in a direction oriented toward the inside of the base material.

Further, because the concentration of the carbide and the nitride gradually decreases as described above, no distinct interface exists between the diffusion layer 20 and the base material. Accordingly, concentration of stress is avoided, and therefore, an increase in brittleness which would otherwise be caused by diffusion of the metal element, is avoided. However, for illustrative purposes in FIG. 2, a boundary line is conveniently shown between the diffusion layer 20 and the base material, simply in order to clarify the presence of the diffusion layer 20.

The hot forging punch 10, constructed as described above, may be used, for example, when hot forging is applied to a workpiece. During this process, forming portions of the hot forging punch 10 press the workpiece. As described above, the forming portions exhibit both high hardness and high strength owing to the presence of the diffusion layer 20, and toughness of the forming portions is ensured. Therefore, the forming portions are scarcely abraded and breakage thereof rarely occurs, even when forging is repeatedly performed, and thus the forming portions have a long service life.

The hot forging punch 10 may be produced, for example, as follows.

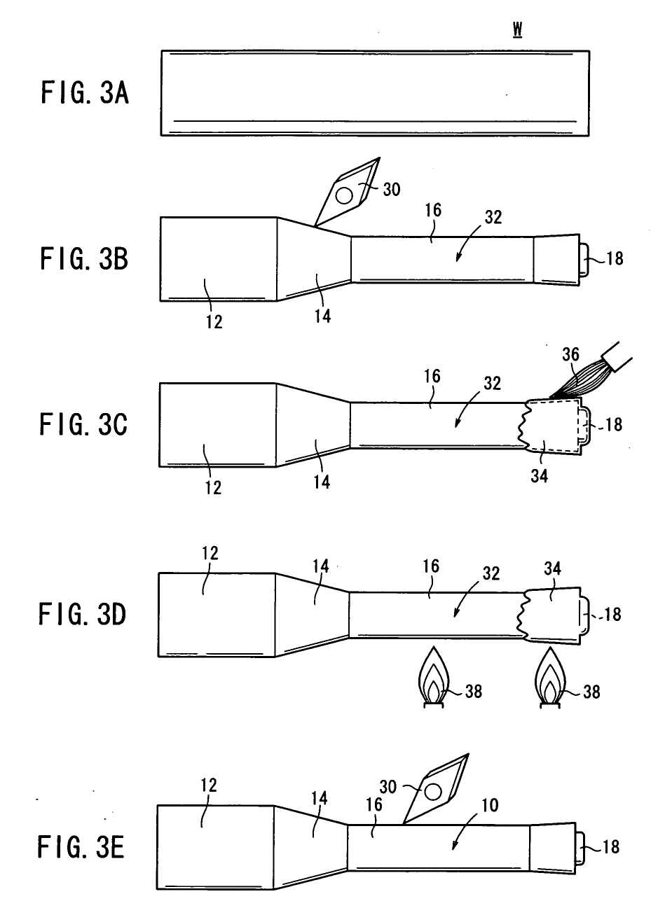

At first, as shown in FIG. 3B, cutting machining is applied to a workpiece W using a bite 30, wherein, as shown in FIG. 3A, the workpiece W has a cylindrical shape and is composed of SKH51, in order to obtain a preformed member 32 having a shape corresponding to the shape of the hot forging punch 10.

Subsequently, as shown in FIG. 3C, a powder of a metal to be diffused is applied to the surface of a part of the preformed member 32 that is to be converted into the forming portions.

The metal powder to be diffused is Al and the metal for increasing hardness of the steel material by forming the carbide and the nitride. Preferred example of the metal other than Al includes Cr, W, Mo, V, Ni, and Mn as described above. In particular, when Cr is present, the nitride layer is deepened, which is preferred. When Mo and Ni are present, an advantage is obtained such that the elongation is increased for the hot forging punch 10.

The powder is applied to using an applying agent 34 prepared by dispersing the powder in a solvent. An organic solvent such as acetone and alcohol, which is vaporized with ease, is preferably selected as the solvent. The powder of, for example, W and Cr is dispersed in the solvent.

Usually, an oxide film is formed on the surface of the SKH51 base material. In order to diffuse Al, Cr, etc. in this state, it is necessary to use an extremely large amount of thermal energy, so that Al, Cr, etc. can pass through the oxide film. In order to avoid this inconvenience, it is preferable to mix a reducing agent, which is capable of reducing the oxide film, into the applying agent 34.

Specifically, a substance, which acts as a reducing agent on the oxide film and which does not react with SKH51, is dispersed or dissolved in the solvent. Preferred examples for such a reducing agent include, without being limited thereto, respective resins of nitrocellulose, polyvinyl, acrylic, melamine, and styrene. The concentration of the reducing agent should be about 5% or more.

The applying agent 34, in which the above-described substances are dissolved or dispersed, is applied respectively to surfaces of the forming portions, by a brush-applying method, using a brush 36 as shown in FIG. 3C. Of course, other known application techniques apart from a brush-applying method may also be used.

Subsequently, a heat treatment is applied to the preformed member 32, in which the applying agent 34 is applied to the surface of the forming portions. Heat treatment is carried out, for example, by applying burner flames 38 on one end surface side of the preformed member 32, as shown in FIG. 3D. Of course, the heat treatment may also be carried out in an inert atmosphere in a heat treating furnace.

As the temperature is raised during this process, the reducing agent begins to decompose at about 250° C., and carbon and hydrogen are produced. Because the oxide film on the preformed member 32 disappears as a result of reduction, under the action of carbon and hydrogen, it is unnecessary for Al, Cr, etc. to pass through an oxide film. Therefore, the time required for diffusion is shortened, and the required thermal energy may be reduced.

As the temperature-raising process continues, C, Fe which are constitutive elements of the SKH51 base material, and C, which is produced by decomposition of the reducing agent, are reacted with Cr or the like, to produce, for example, Cr₆C, Cr₂₃C₆, etc. When Fe further participates in such a reaction, for example, (Fe, Cr)₆C, (Fe, Cr)₂₃C₆ etc. are also produced.

Part of the produced carbides, such as Cr₆C and (Fe, Cr)₆C, is instantaneously decomposed, and return to states of being Fe and Cr. Among them, Cr is subsequently bonded to C and Fe, which are constitutive elements of the base material existing at deeper inner positions of the base material, and C, which exists in a liberated or free state at deeper inner positions of the base material, to newly produce again, for example, Cr₆C, (Fe, Cr)₆C, etc. These Cr₆C, (Fe, Cr)₆C are also instantaneously decomposed and return to states of being Cr. After that, they are bonded to C and Fe, which are constitutive elements of the base material existing at further deeper inner positions of the base material, and C, which exists in a liberated or free state at the further deeper inner positions of the base material, to produce, for example, Cr₆C and (Fe, Cr)₆C once again. The carbides are repeatedly decomposed and produced, as described above, and thus the carbides are diffused into deep inner portions of the base material.

On the other hand, Al causes the lattice defect in the crystalline structure of SKH51, and the diffusion is facilitated by the lattice defect. Unreacted metals other than Al are also diffused by the lattice defect. In other words, when Al causes the lattice defect, a part of the metal is diffused into the preformed member 32 before forming the carbide.

In this way, for example, Cr₆C, Al, Cr, etc. can be diffused into the base material.

Subsequently, for example, the salt bath nitriding is applied to the preformed member 32. In this procedure, the nitriding condition is 550° C. for 14 hours.

The melted salt, which is used for the salt bath nitriding, is satisfactory in convection. Further, the melted salt is uniform in the thermal conductivity, and it has a high density. Therefore, it is possible to quickly heat the preformed member 32 and the applying agent 34. The preformed member 32 is heated to its deep inner portions, because the thermal conductivity is high. Therefore, a large amount of N can be diffused to the deep inner portions of the preformed member 32 from the source of N permeated into the surface of the preformed member 32. Further, an advantage is obtained such that the investment in plant and equipment can be made inexpensive.

Al, Cr and the like, which are diffused into the preformed member 32, are nitrided by the salt bath nitriding to produce AlN and CrN. A part of the carbide is also nitrided to produce the carbonitride. Accordingly, the diffusion layer 20 is formed (see FIG. 2). Further, the nitride layer is also formed in the vicinity of the outermost surface of the diffusion layer 20 in accordance with diffusion and permeation of nitrogen into the preformed member 32.

The concentrations of the carbide, the nitride, and the carbonitride are progressively decreased, and no definite interface is formed between the base material and the terminal end of the diffusion. Accordingly, the compressive residual stress is gently changed. Therefore, it is possible to avoid the concentration of the stress on a specified portion. As a result, it is possible to avoid the occurrence of the brittle fracture. Therefore, it is possible to secure the toughness of the forming portions at which the diffusion layer 20 is formed.

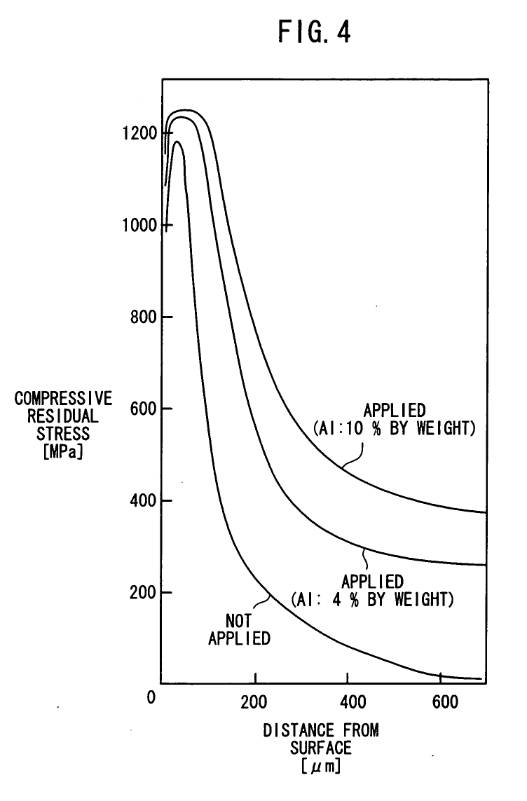

FIG. 4 shows a graph illustrating the compressive residual stress and the depth in relation to a steel material which is subjected to the salt bath nitriding treatment without applying metal powder, and steel materials obtained by performing the procedures as described above after applying the mixed powder containing Al and Cr as the metal powder. The numerical values shown in FIG. 4 are represented by % by weight occupied by Al in the mixed powder. According to FIG. 4, it is clear that the compressive residual stress can be improved by the nitriding treatment after applying the mixed powder containing Al and Cr.

Of course, an ion nitriding may be performed in place of the salt bath nitriding. In this case, a predetermined direct current voltage is applied to between a furnace for a nitriding treatment as a positive electrode and the preformed member 32 as a negative electrode, while a nitriding gas such as nitrogen is supplied to the furnace at a predetermined pressure, to maintain a temperature at 520° C. for 10 hours. In the ion nitriding, nitriding progresses by causing a spattering phenomenon in which nitriding gas ions are rapidly accelerated so as to collide with the preformed member 32.

The nitriding treatment increases a compressive residual stress of the preformed member 32 and enhances its hardness because a large amount of nitrides exist in the diffusion layer 20. As a result, a hot forging punch 10 improved in durability for cracks and breakings is obtained.

Because a compressive stress is applied to the hot forging punch 10 in the direction where the hot forging punch 10 is pressed as the workpiece presses the hot forging punch 10 during forging, the compressive residual stress is preferably large. That is, it is possible to provide the hot forging punch 10 suitable for forging by nitriding.

Before subjecting to a nitriding treatment, residual metal powder or impurities on the surface may be removed, or the surface (the diffusion layer 20) may be slightly ground. With this procedure, the nitriding treatment is performed smoothly and efficiently, due to easy diffusion of N from the surface. As a result, quality of the layer can easily be controlled and time for the nitriding treatment can be reduced. Such effects are remarkable in the ion nitriding.

The nitriding treatment may be conducted a plurality of times.

When the hot forging process is carried out, the hot forging punch 10 is pressed by the workpiece, so that stress to spread the hot forging punch 10 in the direction substantially perpendicular to the pressed direction, that is, the tensile stress acts on the hot forging punch 10. According to the embodiment of the present invention, the compressive residual stress can be increased up to the deep inner portions of the hot forging punch 10. Therefore, it is possible to increase the durability against the tensile stress during the hot forging process.

The thickness of the diffusion layer 20, especially the distance of diffusion of AlN ranges to a depth of about 15 mm from the surface at the maximum. The compressive residual stress at the outermost surface arrives at 1,200 MPa in some cases.

Finally as shown in FIG. 3E, the finishing machining is performed for the preformed member 32 by using the bite 30 to produce the hot forging punch 10.

Carbides and nitrides of Mo, V, and Ni can also be diffused into the base material in the same manner as described above.

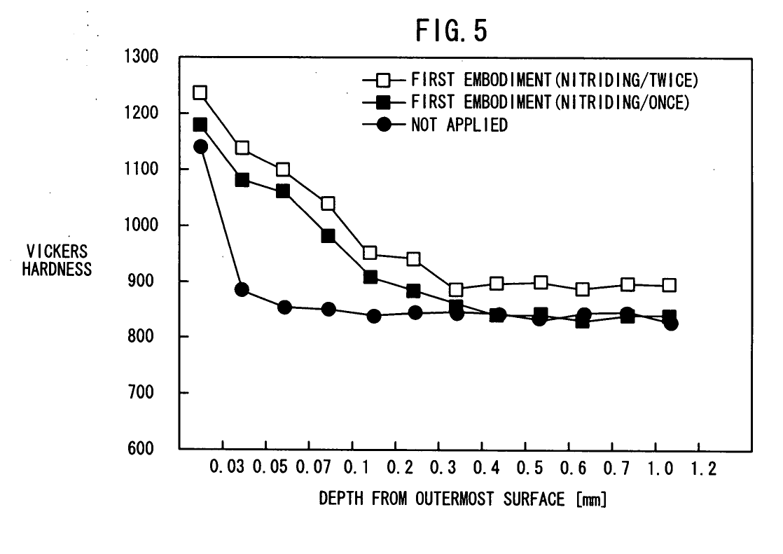

FIG. 5 shows, together with ordinary SKH51 subjected to the nitriding treatment without applying any metal powder, the Vickers hardness measured in the direction directed from the surface side to the inside on a cross sectional surface after cutting the hot forging punch 10 obtained as described above in the longitudinal direction. In this case, the applying material was prepared by mixing metals in a weight ratio of Group III metal: Group IV metal: Group VI metal: Group VII metal: Group VIII metal: Al=2:13:26:20:31:4, followed by being added to an acetone solution containing 10% epoxy resin. The application was performed by the brush-applying, and the thickness of the applying material was 1 mm. The applying material was left to dry, followed by being retained at 1,000° C. to 1,180° C. for 2 hours to perform the hardening treatment. Subsequently, the applying material was retained at 500° C. to 600° C. for 2 hours to perform the tempering treatment.

According to FIG. 5, it is clear that in the case of the ordinary nitriding treatment, hardness is increased only in the range of about 0.07 mm from the outermost surface, and the exhibited hardness is substantially constant thereafter, while in the embodiment of the present invention, the high hardness is exhibited in the range exceeding 0.5 mm from the outermost surface, and hardness is gently decreased.

The case where the nitriding treatment is conducted twice is also shown in FIG. 5. In this case, the Vickers hardness is about 50 higher than that in the case where the nitriding treatment is conducted only once. Accordingly, the compressive residual stress at the surface can be further increased by conducting the nitriding treatment a plurality of times, resulting in a further preferred hot forging punch 10.

In the first embodiment, the nitriding treatment is performed after applying the applying agent and the heat treatment. However, the heat treatment and the nitriding treatment may be performed simultaneously after the applying agent. Alternatively, the applying agent may be applied after the heat treatment, and then the nitriding treatment may be performed. Further alternatively, the applying agent may be applied again after the heat treatment and the nitriding treatment may be performed thereafter. These respective procedures are designated as second to fourth embodiments, which will be explained below as exemplified by hot forging punches. That is, the diffusion layer is also provided in the vicinity of the forming portions of each of the hot forging punches (layered Fe-based alloys) according to the second to fourth embodiments.

In the second embodiment, the diffusion layer is formed by diffusion of the carbide and the nitride of the metal in SKH51 as the base material. Nitrogen diffuses and permeates in the vicinity of the outermost surface of the forming portions. That is, nitrogen is contained in the base material as the underlying material in a form of so-called nitride layer (nitrogen-diffused layer) formed by the nitriding treatment in addition to the carbide and the nitride in the vicinity of the outermost surface in the diffusion layer. In the second embodiment, AlN may or may not be contained as the nitride.

A hot forging punch according to the second embodiment can be produced as follows.

At first, the cutting machining is applied by using a bite 30 as shown in FIG. 3B to a workpiece W having a cylindrical shape composed of SKH51 shown in FIG. 3A to obtain a preformed member 32 having a shape corresponding to the shape of the hot forging punch 10.

Subsequently, as shown in FIG. 3C, metal powder to be diffused is applied to the surface of the forming portions of the preformed member 32. The powder may be applied to using an applying agent 34 prepared by dispersing the powder in a solvent. It is preferable to mix the Al powder in the second embodiment as well, because of the reason as described above. However, the Al powder may not be mixed.

Subsequently, the heat treatment is applied, for example, by burner flames 38 shown in FIG. 3D to the preformed member 32 with the applying agent 34 on the surface of the forming portions. The heat treatment may be performed in an inert atmosphere in a heat treatment furnace.

Subsequently, the preformed member 32 is subjected to a heat treatment in a nitrogen gas atmosphere. That is, the nitriding treatment is carried out in the presence of NH₃ gas or the like. Accordingly, for example, Al and Cr, which diffuses in the preformed member 32, are nitrided to produce AlN and CrN. As a result, the diffusion layer is formed. The carbonitride, in which a part of the carbide is nitride, may be contained in the diffusion layer. The nitride layer is also formed in the vicinity of the outermost surface of the diffusion layer in accordance with the diffusion and the permeation of nitrogen into the preformed member 32.

Finally, as shown in FIG. 3E, the finishing machining is performed for the preformed member 32 by using the bite 30 to produce the hot forging punch 10.

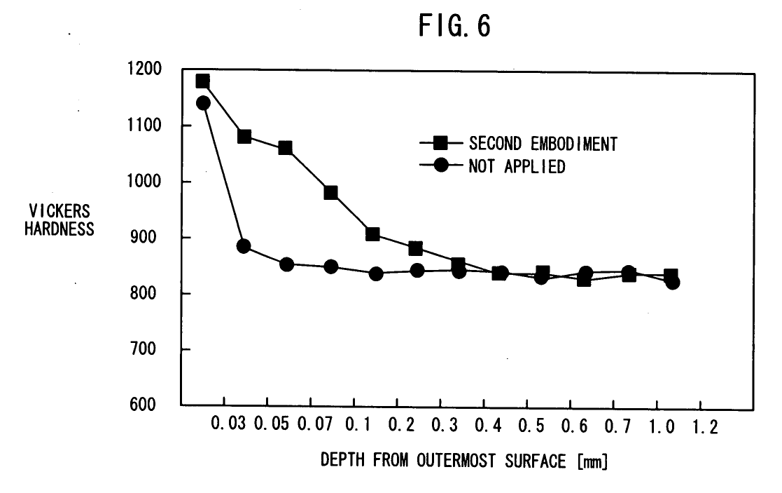

FIG. 6 shows, together with SKH51 subjected to the nitriding treatment without applying metal powder, the Vickers hardness measured in the direction directed from the surface side to the inside on a cross sectional surface after cutting the hot forging punch 10 obtained as described above in the longitudinal direction. In this case, the applying material was prepared by mixing metals in a weight ratio of Group III metal: Group IV metal: Group VI metal: Group VII metal: Group VIII metal: Al=2:13:26:20:31:4, followed by being added to an acetone solution containing 10% epoxy resin. The application was conducted by the brush-applying, and the thickness of the applying material was 1 mm. The applying material was left to dry, followed by being retained at 1,000° C. to 1,180° C. for 2 hours to perform the hardening treatment. Subsequently, the applying material was retained at 500° C. to 600° C. for 2 hours to perform the tempering treatment.

According to FIG. 6, it is clear that in the case of the ordinary nitriding treatment, hardness is increased only in the range of about 0.07 mm from the outermost surface, and the exhibited hardness is substantially constant thereafter, while in the second embodiment, the high hardness is exhibited in the range exceeding 0.5 mm from the outermost surface, and hardness is gently decreased.

In the third embodiment, the diffusion layer is also formed by forming the carbide and the nitride with the metal element diffused from the surface of the base material. In the third embodiment, the operation for diffusing the carbide and the nitride is performed twice. Therefore, the carbide and the nitride are unevenly distributed at high concentrations in the vicinity of the outermost surface in the diffusion layer, and they are progressively decreased in the direction directed toward the inside of the base material. Therefore, hardness of the hot forging punch is the highest in the vicinity of the outermost surface, and progressively lowered at deep inner portions.

The various characteristics represented by hardness are substantially equivalent in the vicinity of the outermost surface of the diffusion layer, because the carbide and the nitride are unevenly distributed at the high concentrations in the vicinity of the outermost surface. Specifically, in the case of a steel material applied with an ordinary nitriding treatment, the Vickers hardness is lower than 900 at a depth of 0.05 mm, although the Vickers hardness is about 1,150 at the outermost surface. On the contrary, in the case of the layered Fe-based alloy according to this embodiment, when the Vickers hardness is about 1,150 at the outermost surface, the Vickers hardness over the range up to a depth of 0.1 mm is 1,035 at the minimum. That is, in this embodiment, the difference between the maximum hardness and the minimum hardness at the portion up to the depth of 0.1 mm from the outermost surface is within 10% as evaluated with the value of Vickers hardness.

In the layered Fe-based alloy (hot forging punch) in which the difference in hardness is small as described above, the strain is decreased. Further, fatigue strength is advantageously increased.

The hot forging punch according to the third embodiment can be produced as follows. Any detailed explanation will be omitted for the operation, work, and process during the treatment to be performed in the same manner as in the first and second embodiments.

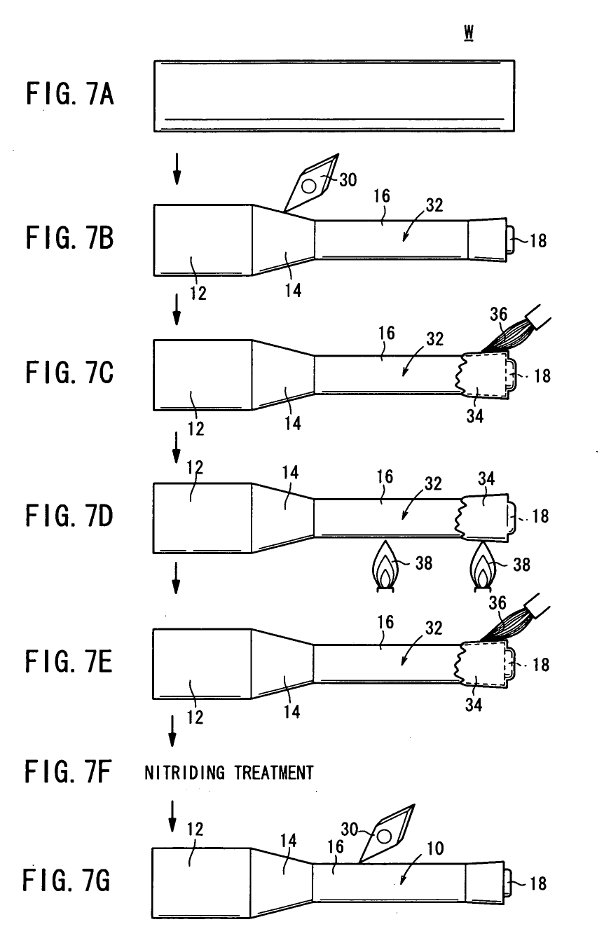

At first, the cutting machining is applied by using a bite 30 as shown in FIG. 7B to a workpiece W having a cylindrical shape composed of SKH51 shown in FIG. 7A to obtain a preformed member 32 having a shape corresponding to the shape of the hot forging punch 10.

Subsequently, as shown in FIG. 7C, metal powder to be diffused is applied to the surface of the preformed member 32. The powder may be applied to using an applying agent 34 prepared by dispersing the powder in a solvent. Also in the third embodiment, it is preferable to mix the Al powder, because of the reason as described above. However, the Al powder may not be mixed.

Subsequently, the heat treatment is applied, for example, by burner flames 38 shown in FIG. 7D to the preformed member 32 applied with the applying agent 34 on the surface of the forming portions. The heat treatment may be performed in an inert atmosphere in a heat treatment furnace.

Subsequently, as shown in FIG. 7E, the applying agent 34, i.e., the metal powder as described above is applied again to the surface of the preformed member 32. The re-application may be conducted in the same method as in the first time application. The type of the metal may differ between the first time applying agent 34 and the second time applying agent 34.

Subsequently, as shown in FIG. 7F, the nitriding treatment is applied to the preformed member 32 applied with the applying agent 34 again in accordance with a known technique including, for example, the gas nitriding, the ion nitriding, the salt bath nitriding, and the plasma nitriding. In particular, the salt bath nitriding and the ion nitriding are preferred. The nitriding condition is, for example, 550° C. for 14 hours in the case of the salt bath nitriding.

Heating during the nitriding treatment makes the metal powder, which is applied again, diffuse into the preformed member 32 while being reversibly changed into the carbide in accordance with the mechanism described above. On the other hand, for example, Al and Cr, which are diffused into the preformed member 32, are nitride to produce AlN and CrN in accordance with the nitriding treatment. Further, a part of the carbide is also nitrided to form the carbonitride. Accordingly, the diffusion layer is formed.

The carbide, the nitride, and the carbonitride are unevenly distributed at high concentrations in the portion ranging to a depth of about 0.1 mm in the diffusion layer. Therefore, the difference between the maximum hardness and the minimum hardness at the portion up to at the depth of 0.1 mm from the outermost surface is within 10% as evaluated with the value of Vickers hardness.

Further, the nitride layer is also formed in the vicinity of the outermost surface of the diffusion layer 20 in accordance with the diffusion and the permeation of nitrogen into the preformed member 32.

Finally, as shown in FIG. 7G, the finishing machining is performed for the preformed member 32 by using the bite 30 to produce a hot forging punch.

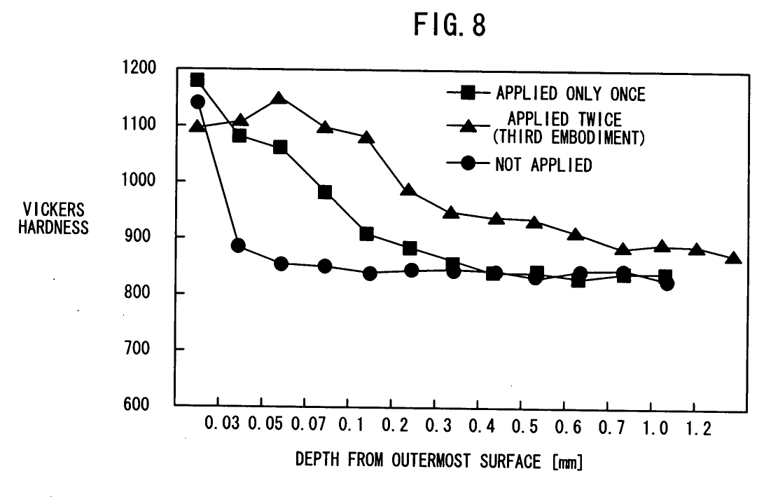

FIG. 8 shows, the Vickers hardness measured in the direction directed from the surface side to the inside on a cross sectional surface after cutting the hot forging punch 10 obtained in accordance with the procedure shown in FIG. 7 in the longitudinal direction, together with SKH51 subjected to the nitriding treatment without applying metal powder and SKH51 subjected to the nitriding treatment after applying the metal powder only once. In any case in which the metal powder is applied, the applying material to be used was prepared by mixing metals in a weight ratio of Group III metal: Group IV metal: Group VI metal: Group VII metal: Group VIII metal: Al=2:13:26:20:31:4, followed by being added to an acetone solution containing 10% epoxy resin. The application was conducted by the brush-applying, and the thickness of the applying material was 1 mm. The applying material was left to dry, followed by being retained at 1,000° C. to 1,180° C. for 2 hours to perform the hardening treatment. Subsequently, the applying material was retained at 500° C. to 600° C. for 2 hours to perform the tempering treatment.

According to FIG. 8, it is clear that in the case of the ordinary nitriding treatment, hardness is increased only in the range of about 0.07 mm from the outermost surface, and the exhibited hardness is substantially constant thereafter, while in this embodiment, the high hardness is exhibited in the range exceeding 1.0 mm from the outermost surface, and hardness is gently decreased.

According to FIG. 8, it is also clear that when the metal powder is applied twice, hardness can be made substantially constant in the vicinity of the outermost surface, i.e., up to a depth of 0.1 mm from the outermost surface, as compared with the case in which the application is performed only once. Specifically, the maximum hardness is 1,150, and the minimum hardness is 1,100 in this range. As described above, in the case of the steel material in which the difference in hardness is small, the strain is decreased, and the fatigue strength is increased.

That is, when the metal powder is applied twice, it is possible to improve hardness and strength up to a deep inner portion. Further, it is possible to obtain the hot forging punch 10 in which the strain is small, the fatigue strength is large, and hence the service life is further prolonged.

In the fourth embodiment, it is recognized that a layered microstructure containing ferrite and cementite, i.e., a pearlite microstructure exists in SKH51 as the base material. The pearlite microstructure is formed by the hardening treatment and the tempering treatment as described later on.

In the fourth embodiment, the diffusion layer formed by diffusion of the carbide and the nitride of metal into SKH51, also exists at the surface layer portion of the forming portions. Further, nitrogen diffuses and permeates to form the nitride layer (nitrogen-diffused layer) in the vicinity of the outermost surface of the forming portions. In the fourth embodiment, the various types of nitrides exist to intervene between the fine carbides and the pearlite microstructure.

The hot forging punch according to the fourth embodiment can be produced as follows. Detailed explanation will be omitted for the operation, work, and process during the treatment to be performed in the same manner as in the first to third embodiments.

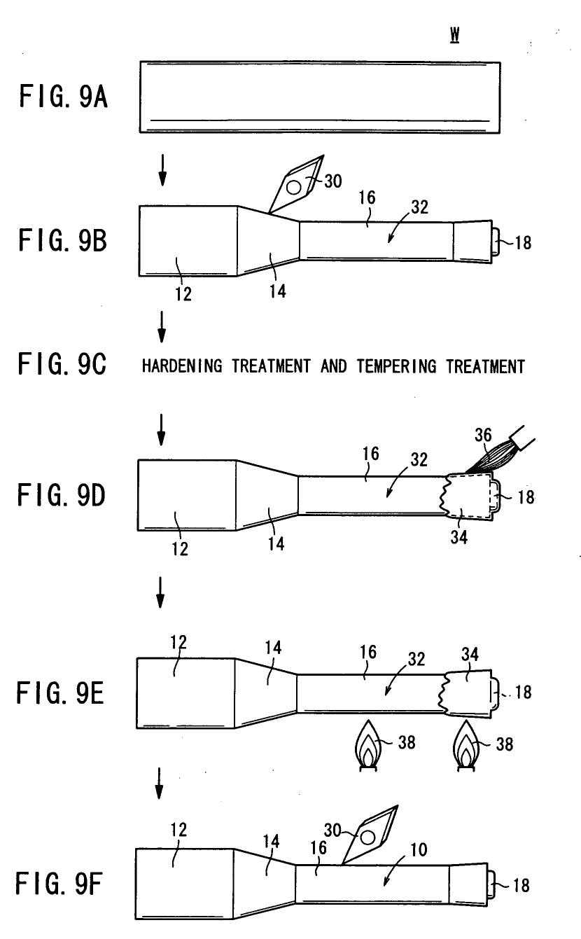

At first, the cutting machining is applied by using a bite 30 as shown in FIG. 9B to a workpiece W having a cylindrical shape composed of SKH51 shown in FIG. 9A to obtain a preformed member 32 having a shape corresponding to the shape of the hot forging punch 10.

Subsequently, the hardening treatment and the tempering treatment are applied to the preformed member 32 as shown in FIG. 9C.

As well-known, the hardening treatment is carried out such that a hypoeutectoid steel is heated to a temperature of not less than the Ac3 transformation temperature or a hypereutectoid steel is heated to a temperature of not less than the Ac1 transformation temperature, followed by being cooled with a cooling agent such as oil. Accordingly, the austenite, which is contained in the metal microstructure of the preformed member 32, is subjected to the transformation into the maltensite, and hardness and strength of the preformed member 32 are consequently improved.

However, if only the hardening treatment is applied, the preformed member 32 exhibits the brittleness. The tempering treatment is carried out for improvement in brittleness.

When the tempering treatment is carried out, the maltensite is changed into the ferrite and the cementite which are thermodynamically stable. When they are aligned in a layered form, the pearlite microstructure is formed. That is, the preformed member 32, which contains the pearlite microstructure, is obtained.

In this procedure, the temperature during the tempering treatment is set to be not less than 150° C. and less than 400° C. It is preferable to avoid a temperature at which the tempering brittleness occurs. For example, in this embodiment, the temperature is preferably 150° C. to 250° C. or not less than 350° C. and less than 400° C., because SKH51 is a high speed tool steel.

Subsequently, as shown in FIG. 9D, metal powder to be diffused is applied to the surface of the preformed member 32. The powder may be applied using an applying agent 34 prepared by dispersing the powder in a solvent. It is preferable to mix the Al powder in the fourth embodiment as well, because of the reason as described above. However, the Al powder may not be mixed.

Subsequently, the heat treatment is applied, for example, by burner flames 38 shown in FIG. 9D to the preformed member 32 applied with the applying agent 34 on the surface of the forming portions. The heat treatment may be performed in an inert atmosphere in a heat treatment furnace.

Subsequently, the nitriding treatment is applied to the preformed member 32 in accordance with a known technique including, for example, the gas nitriding, the ion nitriding, the salt bath nitriding, and the plasma nitriding. In particular, the salt bath nitriding or the ion nitriding is preferred. The nitriding condition is, for example, 550° C. for 14 hours in the case of the salt bath nitriding.

For example, Al and Cr, which diffuses into the preformed member 32, are nitrided in accordance with the nitriding treatment to produce AlN and CrN. A part of the carbide is also nitrided to form carbonitride. Accordingly, the diffusion layer is formed. Further, the nitride layer is also formed in the vicinity of the outermost surface of the diffusion layer in accordance with the diffusion and the permeation of nitrogen into the preformed member 32.

Finally, as shown in FIG. 9F, the finishing machining is performed for the preformed member 32 by using the bite 30 to produce the hot forging punch.

The base material may contain a troostite microstructure or a sorbite microstructure in place of the pearlite microstructure. In this case, the tempering temperature in FIG. 9C may be not less than 400° C.

In the fourth embodiment, when the tempering temperature is made different as described above, it is possible to obtain the different main microstructure for constructing the metal microstructure of the preformed member 32. In the present invention, the method for producing the layered Fe-based alloy containing the troostite microstructure or the sorbite microstructure in the base material includes the procedure in which the steps shown in FIG. 9D and its subsequences are carried out by using a refining agent. That is, the refining agent is commercially available, which is subjected to the tempering treatment at a temperature of less than 400° C. and not more than the Ac1 transformation temperature after the hardening treatment. Therefore, it is regarded that the hardening treatment and the tempering treatment have been previously performed before being commercially obtained. Of course, it is not necessary to conduct the hardening treatment and the tempering treatment after obtaining the commercially available refining agent.

When the troostite microstructure or the sorbite microstructure is formed, the hot forging punch exhibits more excellent toughness. That is, when the so-called refining is performed, a hot forging punch, which exhibits the excellent toughness while providing the high hardness, is advantageously obtained.

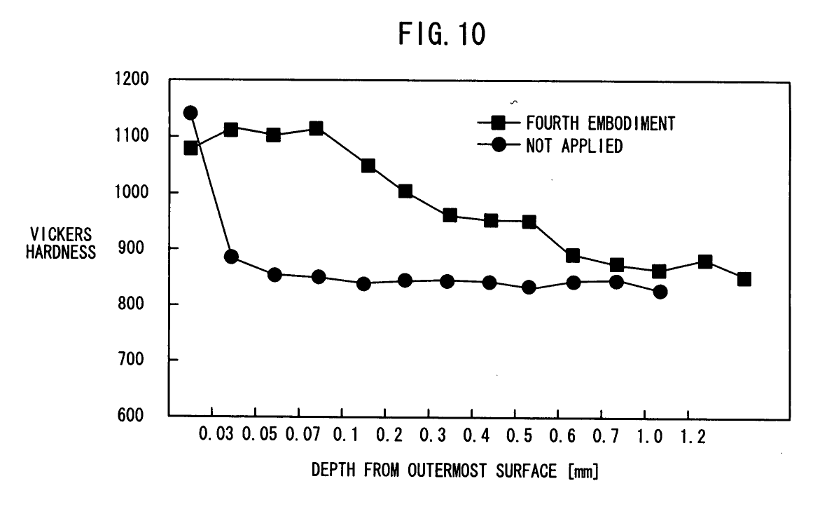

FIG. 10 shows the Vickers hardness measured in the direction directed from the surface side to the inside on a cross sectional surface after cutting the hot forging punch obtained in accordance with the procedure shown in FIG. 9 in the longitudinal direction, together with SKH51 subjected to the nitriding treatment without applying metal powder. In this case, the applying material was prepared by mixing metals in a weight ratio of Group III metal: Group IV metal: Group VI metal: Group VII metal: Group VIII metal: Al=2:13:26:20:31:4, followed by being added to an acetone solution containing 10% epoxy resin. The application was performed by the brush-applying, and the thickness of the applying material was 1 mm. Before applying the applying material, the hardening treatment was performed by being retained at 1,000° C. to 1,180° C. for 2 hours. Subsequently, the tempering treatment was performed by being retained at 500° C. to 600° C. for 2 hours. That is, in this case, the sorbite microstructure is contained in the base material.

According to FIG. 10, it is clear that in the case of the ordinary nitriding treatment, hardness is increased only in the range of about 0.07 mm from the outermost surface, and the exhibited hardness is substantially constant thereafter, while in the fourth embodiment, the high hardness is exhibited in the range exceeding 1.0 mm from the outermost surface, and hardness is gently decreased.

In any one of the second to fourth embodiments, the thickness of the diffusion layer, especially the distance of diffusion of AlN ranges to a depth of about 15 mm from the surface at the maximum, and the compressive residual stress at the outermost surface arrives at 1,200 MPa in some cases.

The concentrations of the carbide, the nitride, and the carbonitride are progressively decreased in the same manner as in the first embodiment, and no distinct interface appears between the base material and the terminal end of diffusion. Accordingly, because the compressive residual stress is gently changed, the concentration of the stress on a specified portion is avoided. As a result, it is possible to avoid the occurrence of the brittle fracture, securing the toughness of the forming portions with the diffusion layer 20.

In the embodiments described above, the explanation has been made as exemplified by the hot forging punch as the layered Fe-based alloy. However, there is no special limitation thereto, but may be other members such as dies including punches for cold forging and those for warm forging.

The carbide may or may not be those in which the composition formula is represented by M₇C₃.

1. A layered Fe-based alloy comprising a base material composed of an Fe-based alloy and a diffusion layer which is formed by diffusion of a carbide and a nitride from a surface side of said base material and which has a hardness higher than that of said base material, wherein:
at least AlN is contained as said nitride; and
concentrations of said carbide and said nitride are progressively decreased at deeper positions in said diffusion layer.

2. The layered Fe-based alloy according to claim 1, wherein said carbide is at least one of carbides of Cr, W, Mo, V, Ni, and Mn, and at least one of nitrides of Cr, W, Mo, V, Ni, and Mn is further contained as said nitride.

3. The layered Fe-based alloy according to claim 2, wherein said carbide has a compositional formula of M₆C or M₂₃C₆ wherein M represents a metal element.

4. The layered Fe-based alloy according to claim 1, wherein said carbide is a carbide of solid solution of Fe and at least one of Cr, W, Mo, V, Ni, and Mn, and said nitride is at least one of nitrides of Cr, W, Mo, V, Ni, and Mn.

5. The layered Fe-based alloy according to claim 4, wherein said carbide has a compositional formula of (Fe, M)₆C or (Fe, M)₂₃C₆ wherein M represents a metal element.

6. A method for producing a layered Fe-based alloy comprising a base material composed of an Fe-based alloy and a diffusion layer which is formed by diffusion of a carbide and a nitride from a surface side of said base material and which has a hardness higher than that of said base material, wherein at least AlN is contained as said nitride, and concentrations of said carbide and said nitride are progressively decreased at deeper positions in said diffusion layer, said method comprising the steps of:
applying metal powder which contains Al powder to a surface of said Fe-based alloy;
heat-treating said Fe-based alloy applied with said metal powder; and
subjecting said heat-treated Fe-based alloy to a nitriding treatment.

7. The method for producing said layered Fe-based alloy according to claim 6, wherein powder of at least one of Cr, W, Mo, V, Ni, and Mn is used as said metal powder.

8. A layered Fe-based alloy comprising a base material composed of an Fe-based alloy and a diffusion layer which is formed by diffusion of a carbide and a nitride from a surface side of said base material and which has a hardness higher than that of said base material, wherein
concentrations of said carbide and said nitride are progressively decreased at deeper positions in said diffusion layer.

9. The layered Fe-based alloy according to claim 8, wherein said carbide is at least one of carbides of Cr, W, Mo, V, Ni, and Mn, and at least one of nitrides of Cr, W, Mo, V, Ni, and Mn is further contained as said nitride.

10. The layered Fe-based alloy according to claim 9, wherein said carbide has a compositional formula of M₆C or M₂₃C₆ wherein M represents a metal element.

11. The layered Fe-based alloy according to claim 8, wherein said carbide is a carbide of solid solution of Fe and at least one of Cr, W, Mo, V, Ni, and Mn, and said nitride is at least one of nitrides of Cr, W, Mo, V, Ni, and Mn.

12. The layered Fe-based alloy according to claim 11, wherein said carbide has a compositional formula of (Fe, M)₆C or (Fe, M)₂₃C₆ wherein M represents a metal element.

13. The layered Fe-based alloy according to claim 8, wherein AlN is contained as said nitride.

14. A method for producing a layered Fe-based alloy comprising a base material composed of an Fe-based alloy and a diffusion layer which is formed by diffusion of a carbide and a nitride from a surface side of said base material and which has a hardness higher than that of said base material, wherein concentrations of said carbide and said nitride are progressively decreased at deeper positions in said diffusion layer, said method comprising the steps of:
applying metal powder which contains Al powder to a surface of said Fe-based alloy; and
subjecting said Fe-based alloy to a nitriding treatment in a nitriding gas atmosphere.

15. The method for producing said layered Fe-based alloy according to claim 14, wherein powder of at least one of Cr, W, Mo, V, Ni, and Mn is used as said metal powder.

16. The method for producing said layered Fe-based alloy according to claim 14, wherein mixed powder, in which Al is mixed, is used as said metal powder.

17. A layered Fe-based alloy comprising a base material composed of an Fe-based alloy and a diffusion layer which is formed by diffusion of a carbide and a nitride from a surface side of said base material and which has a hardness higher than that of said base material, wherein
said hardness is progressively decreased as concentrations of said carbide and said nitride are progressively decreased at deeper positions in said diffusion layer, and a difference between a maximum hardness and a minimum hardness, which is provided at a part ranging from an outermost surface to a depth of 0.1 mm, is within 10% as evaluated with a value of Vickers hardness.

18. The layered Fe-based alloy according to claim 17, wherein said carbide is at least one of carbides of Cr, W, Mo, V, Ni, and Mn, and at least one of nitrides of Cr, W, Mo, V, Ni, and Mn is further contained as said nitride.

19. The layered Fe-based alloy according to claim 18, wherein said carbide has a compositional formula of M₆C or M₂₃C₆ wherein M represents a metal element.

20. The layered Fe-based alloy according to claim 17, wherein said carbide is a carbide of solid solution of Fe and at least one of Cr, W, Mo, V, Ni, and Mn, and said nitride is at least one of nitrides of Cr, W, Mo, V, Ni, and Mn.

21. The layered Fe-based alloy according to claim 20, wherein said carbide has a compositional formula of (Fe, M)₆C or (Fe, M)₂₃C₆ wherein M represents a metal element.

22. The layered Fe-based alloy according to claim 17, wherein AlN is contained as said nitride.

23. A method for producing a layered Fe-based alloy comprising a base material composed of an Fe-based alloy and a diffusion layer which is formed by diffusion of a carbide and a nitride from a surface side of said base material and which has a hardness higher than that of said base material, wherein said hardness is progressively decreased as concentrations of said carbide and said nitride are progressively decreased at deeper positions in said diffusion layer, and a difference between a maximum hardness and a minimum hardness, which is provided at a part ranging from an outermost surface to a depth of 0.1 mm, is within 10% as evaluated with a value of Vickers hardness, said method comprising the steps of:
applying metal powder to a surface of said Fe-based alloy;
heat-treating said Fe-based alloy applied with said metal powder;
applying said metal powder to said surface of said Fe-based alloy again; and
subjecting said Fe-based alloy to which said metal powder has been applied again to a nitriding treatment.

24. The method for producing said layered Fe-based alloy according to claim 23, wherein powder of at least one of Cr, W, Mo, V, Ni, and Mn is used as said metal powder.

25. The method for producing said layered Fe-based alloy according to claim 23, wherein mixed powder, in which Al is mixed, is used as said metal powder.

26. A layered Fe-based alloy comprising a base material composed of an Fe-based alloy containing a pearlite microstructure and a diffusion layer which is formed by diffusion of a carbide and a nitride from a surface side of said base material and which has a hardness higher than that of said base material, wherein
concentrations of said carbide and said nitride are progressively decreased at deeper positions in said diffusion layer.

27. The layered Fe-based alloy according to claim 26, wherein said carbide is at least one of carbides of Cr, W, Mo, V, Ni, and Mn, and at least one of nitrides of Cr, W, Mo, V, Ni, and Mn is further contained as said nitride.

28. The layered Fe-based alloy according to claim 27, wherein said carbide has a compositional formula of M₆C or M₂₃C₆ wherein M represents a metal element.

29. The layered Fe-based alloy according to claim 26, wherein said carbide is a carbide of solid solution of Fe and at least one of Cr, W, Mo, V, Ni, and Mn, and said nitride is at least one of nitrides of Cr, W, Mo, V, Ni, and Mn.

30. The layered Fe-based alloy according to claim 29, wherein said carbide has a compositional formula of (Fe, M)₆C or (Fe, M)₂₃C₆ wherein M represents a metal element.

31. The layered Fe-based alloy according to claim 26, wherein AlN is contained as said nitride.

32. A layered Fe-based alloy comprising a base material composed of an Fe-based alloy containing a troostite microstructure or a sorbite microstructure and a diffusion layer which is formed by diffusion of a carbide and a nitride from a surface side of said base material and which has a hardness higher than that of said base material, wherein
concentrations of said carbide and said nitride are progressively decreased at deeper positions in said diffusion layer.

33. The layered Fe-based alloy according to claim 32, wherein said carbide is at least one of carbides of Cr, W, Mo, V, Ni, and Mn, and at least one of nitrides of Cr, W, Mo, V, Ni, and Mn is further contained as said nitride.

34. The layered Fe-based alloy according to claim 33, wherein said carbide has a compositional formula of M₆C or M₂₃C₆ wherein M represents a metal element.

35. The layered Fe-based alloy according to claim 32, wherein said carbide is a carbide of solid solution of Fe and at least one of Cr, W, Mo, V, Ni, and Mn, and said nitride is at least one of nitrides of Cr, W, Mo, V, Ni, and Mn.

36. The layered Fe-based alloy according to claim 35, wherein said carbide has a compositional formula of (Fe, M)₆C or (Fe, M)₂₃C₆ wherein M represents a metal element.

37. The layered Fe-based alloy according to claim 32, wherein AlN is contained as said nitride.

38. A method for producing a layered Fe-based alloy comprising a base material composed of an Fe-based alloy containing a pearlite microstructure and a diffusion layer which is formed by diffusion of a carbide and a nitride from a surface side of said base material and which has a hardness higher than that of said base material, wherein concentrations of said carbide and said nitride are progressively decreased at deeper positions in said diffusion layer, said method comprising the steps of:
applying a hardening treatment to said Fe-based alloy and then performing a tempering treatment by heating said Fe-based alloy to a temperature of not less than 150° C. and less than 400° C.;
applying metal powder to a surface of said Fe-based alloy; and
subjecting said Fe-based alloy to a nitriding treatment.

39. The method for producing said layered Fe-based alloy according to claim 38, wherein powder of at least one of Cr, W, Mo, V, Ni, and Mn is applied as said metal powder.

40. The method for producing said layered Fe-based alloy according to claim 38, wherein mixed powder, in which Al is mixed, is used as said metal powder.

41. A method for producing a layered Fe-based alloy comprising a base material composed of an Fe-based alloy containing a troostite microstructure or a sorbite microstructure and a diffusion layer which is formed by diffusion of a carbide and a nitride from a surface side of said base material and which has a hardness higher than that of said base material, wherein concentrations of said carbide and said nitride are progressively decreased at deeper positions in said diffusion layer, said method comprising the steps of:
applying a hardening treatment to said Fe-based alloy and then performing a tempering treatment by heating said Fe-based alloy to a temperature of not less than 400° C. and not more than an Ac1 transformation temperature;
applying metal powder to a surface of said Fe-based alloy; and
subjecting said Fe-based alloy to a nitriding treatment.

42. The method for producing said layered Fe-based alloy according to claim 41, wherein powder of at least one of Cr, W, Mo, V, Ni, and Mn is applied as said metal powder.

43. The method for producing said layered Fe-based alloy according to claim 41, wherein mixed powder, in which Al is mixed, is used as said metal powder.
